(19) United States
(12) Patent Application Publication
(10) Pub. No.: US 2024/0246435 A1
(43) Pub. Date: Jul. 25, 2024

(54) SERVER DEVICE

(71) Applicant: Toyota Jidosha Kabushiki Kaisha, Toyota-shi (JP)

(72) Inventors: Takahiro Aoki, Saitama-shi (JP); Yuta Takata, Toyota-shi (JP); Haruki Oguri, Toyota-shi (JP); Takashi Yamazaki, Nagoya-shi (JP); Tsuyoshi Okada, Nagoya-shi (JP); Hiroki Asao, Tokyo (JP)

(73) Assignee: Toyota Jidosha Kabushiki Kaisha, Toyota-shi (JP)

(21) Appl. No.: 18/533,735

(22) Filed: Dec. 8, 2023

(30) Foreign Application Priority Data
Jan. 24, 2023 (JP) 2023-008999

(51) Int. Cl. B60L 53/30; B60L 3/00

(52) U.S. Cl. CPC B60L 53/305; B60L 3/0046; B60L 2240/622; B60L 2250/16

(57) ABSTRACT

The server device communicates with a plurality of power supply vehicles that dispatch from a power supply base to the power supply destination and return to the power supply base through the communication unit through the communication unit, and performs a first power supply during returning. a control unit that instructs the vehicle and a second power supply vehicle on the move to merge at a junction and provide the remaining power of the first power supply vehicle to the second power supply vehicle.

### CROSS-REFERENCE TO RELATED APPLICATION

This application claims priority to Japanese Patent Application No. 2023-008999 filed on Jan. 24, 2023, incorporated herein by reference in its entirety.

### BACKGROUND

### 1. Technical Field

The present disclosure relates to a server device.

### 2. Description of Related Art

A battery electric vehicle (Electric Vehicle or EV) or the like driven by a battery occasionally runs out of electric power, that is, runs out of power, during travel. Various techniques have been proposed to resolve or avoid such a situation. For example, Japanese Unexamined Patent Application Publication No. 2019-093968 (JP 2019-093968 A) discloses a technique of charging a vehicle running out of power from another vehicle.

### SUMMARY

A power supply vehicle that supplies power to a vehicle running out of power needs to be replenished with power for power supply by charging a battery for power supply when supplying power, but there is room to improve the efficiency of replenishment with power for power supply.

The present disclosure provides a server device or the like that makes it possible to improve the efficiency of replenishment with power for power supply.

The present disclosure provides a server device including:
a communication unit; and
a control unit that communicates through the communication unit with a plurality of power supply vehicles to be dispatched from a supply base of power to a supply destination of the power and return to the supply base, and that instructs a first power supply vehicle returning and a second power supply vehicle dispatched to meet each other at a meeting point and supply remaining power in the first power supply vehicle to the second power supply vehicle.

According to the server device or the like according to the present disclosure, it is possible to improve the efficiency of replenishment with power for power supply.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a configuration example of a vehicle management system;

FIG. 2 is a diagram showing an operation procedure example of the server device and the power supply vehicle; and

FIG. 3 is a diagram illustrating an operation procedure example of the server device.

### DETAILED DESCRIPTION OF EMBODIMENTS

Embodiments will be described below with reference to the drawings.

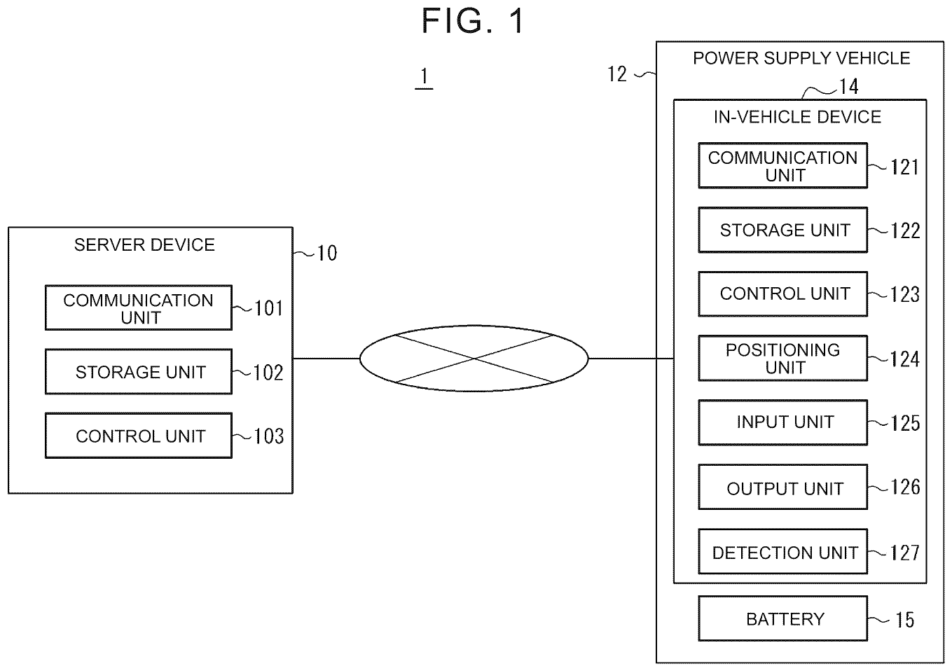

FIG. 1 is a diagram showing a configuration example of a vehicle management system according to one embodiment. The vehicle management system 1 has one or more server devices 10 and a plurality of power supply vehicles 12 that are connected to each other via a network 11 so as to be able to communicate information. The server device 10 is, for example, a server computer belonging to a cloud computing system or other computing systems and functioning as a server implemented with various functions. The power supply vehicle 12 is a passenger car or commercial vehicle having a communication function and an information processing function, and is connected to the network 11 via a mobile communication network. The power supply vehicle 12 is equipped with a battery 15 as a power source for supplying power to other vehicles that are out of power. The power supply vehicle 12 is, for example, a gasoline vehicle, or a battery electric vehicle (BEV), a hybrid electric vehicle (HEV), a plug-in hybrid electric vehicle (PHEV), a fuel cell electric vehicle driven by electric power of an on-board battery 15, for example. (FCEV) and the like. The power supply vehicle 12 may be driven by a driver or may have any level of automated driving. Network 11 may be, for example, the Internet, but may also include ad-hoc networks, LANs, Metropolitan Area Networks (MANs), or other networks or any combination thereof.

In the present embodiment, the vehicle management system 1 is a system for assisting rush charging by the power supply vehicle 12 of a vehicle such as a BEV, HEV, or PHEV that has fallen into an electrical failure state (hereinafter referred to as an electrical failure vehicle). In the rush charging, the power supply vehicle 12 moves to the position of the power supply vehicle, and the battery of the power supply vehicle 12 is charged from the battery 15 of the power supply vehicle 12 to supply power. In the vehicle management system 1, the plurality of power supply vehicles 12 sequentially perform drive power supply rotation under the control of the server device 10. One rotation includes the dispatch of the power supply vehicle 12 from the power replenishment base to the power supply destination and the return to the replenishment base. The supply base is, for example, a charging station or the like. Further, the supply destination is, for example, the position of the vehicle that is out of power (hereinafter referred to as the power feeding position).

The control unit 103 of the server device 10 instructs the power supply vehicle 12 returning and the power supply vehicle 12 currently dispatched to merger at a junction and provide the remaining power of the power supply vehicle 12 currently returning to the power supply vehicle 12 currently dispatched. Here, the power supply vehicle 12 that is returning is the power supply vehicle 12 that returns to the power supply base after completing power supply at the supply destination. Further, the power supply vehicle 12 that is being dispatched is the power supply vehicle 12 that is dispatched from the replenishment base and before completing the power supply at the supply destination. When the power supply vehicle 12 on the move supplies power to a plurality of supply destinations, even if the power for power supply is reduced before the completion of power supply, the remaining power of the power supply vehicle 12 on the way back is provided, and the remaining power for power supply is supplied. It is possible to more reliably avoid falling into a power shortage. Therefore, it is possible to improve the supply efficiency of the electric power for power supply in the power supply vehicle 12.

Next, a configuration example of the server device 10 will be described. The server device 10 has a communication unit 101, a storage unit 102 and a control unit 103. The server device 10 is, for example, one computer. Alternatively, the server device 10 may be composed of two or more computers that are connected such that information communication can be performed and operate in cooperation with each other. In that case, the arrangement shown in FIG. 1 is conveniently located on two or more computers.

The communication unit 101 includes one or more communication interfaces. The communication interface is, for example, a LAN interface. The communication unit 101 receives information used for the operation of the server device 10 and transmits information obtained by the operation of the server device 10. The server device 10 is connected to the network 11 by the communication unit 101 and performs information communication with the power supply vehicle 12 and the facility 13 via the network 11.

The storage unit 102 includes, for example, one or more semiconductor memories, one or more magnetic memories, one or more optical memories, or a combination of at least two of these that function as a main memory, auxiliary memory, or cache memory. A semiconductor memory is, for example, a Random Access Memory (RAM) or a Read Only Memory (ROM). RAM is, for example, Static RAM (SRAM) or Dynamic RAM (DRAM). The ROM is, for example, an electrically erasable programmable ROM (EEPROM). Storage unit 102 stores information used for the operation of control unit 103 and information obtained by the operation of control unit 103.

Control unit 103 includes one or more processors, one or more dedicated circuits, or a combination thereof. The processor is, for example, a general-purpose processor such as a Central Processing Unit (CPU), or a dedicated processor such as a Graphics Processing Unit (GPU) that specializes in a particular process. A dedicated circuit is, for example, a Field-Programmable Gate Array (FPGA), an Application Specific Integrated Circuit (ASIC), or the like. The control unit 103 executes information processing related to the operation of the server device 10 while controlling each component of the server device 10.

The functions of the server device 10 are realized by executing the control program by the processor included in the control unit 103. The control program is a program for causing a computer to execute a step process included in the operation of the server device 10, thereby causing the computer to implement a function corresponding to the step process. That is, the control program is a program for causing the computer to function as the server device 10. Also, part or all of the functions of the server device 10 may be implemented by a dedicated circuit included in the control unit 103. Further, the control program may be stored in a non-transitory recording/storage medium that can be read by the server device 10, and the server device 10 may read the control program from the medium.

Next, a configuration example of the power supply vehicle 12 will be described. The power supply vehicle 12 has an in-vehicle device 14 and a battery 15. The in-vehicle device 14 has a communication unit 121, a storage unit 122, a control unit 123, a positioning unit 124, an input unit 125, an output unit 126 and a detection unit 127. One or more of these units may be configured as one control device, or may be configured by a personal computer including a tablet terminal, a smartphone terminal, or a navigation device. Or each part may be connected so that information communication is possible via the in-vehicle network based on standards, such as Controller Area Network (CAN). Each part of the in-vehicle device 14 is configured to be operable by the battery 15 even when the power supply vehicle 12 is parked and the accessory is turned off, for example. The battery 15 is a battery that charges and discharges electric power for power supply to be provided to an electric vehicle. Battery 15 may also include a battery that charges and discharges electric power for driving power supply vehicle 12. Battery 15 is, for example, one or more lithium-ion batteries.

The communication unit 121 includes one or more communication interfaces. The communication interface is, for example, an interface compatible with mobile communication standards such as a long term evolution (LTE), 4G, or 5G. The communication unit 121 receives information used for the operation of the control unit 123 and transmits information obtained by the operation of the control unit 123. The control unit 123 is connected to the network 11 via a mobile communication base station by the communication unit 121 and performs information communication with the server device 10 and the like via the network 11.

The storage unit 122 includes one or more semiconductor memories, one or more magnetic memories, one or more optical memories, or a combination of at least two of them. The semiconductor memory is, for example, a RAM or a ROM. The RAM is, for example, a static random access memory (SRAM) or a dynamic random access memory (DRAM). The ROM is, for example, an EEPROM. The storage unit 122 functions as, for example, a main memory device, an auxiliary memory device, or a cache memory. The storage unit 122 stores information used for the operation of the control unit 123 and information obtained by the operation of the in-vehicle device 14.

Control unit 123 includes one or more processors, one or more dedicated circuits, or a combination thereof. The processor is a general-purpose processor such as a CPU, or a dedicated processor specialized for a specific process. The dedicated circuit is, for example, an FPGA or an ASIC. The control unit 123 executes information processing related to the operation of the power supply vehicle 12 while controlling each unit of the in-vehicle device 14.

The positioning unit 124 includes one or more Global Navigation Satellite System (GNSS) receivers. GNSS includes, for example, Global Positioning System (GPS), Quasi-Zenith Satellite System (QZSS), BeiDou, Global Navigation Satellite System (GLONASS), and/or Galileo. The positioning unit 124 acquires position information of the power supply vehicle 12.

The input unit 125 includes one or more input interfaces. The input interface is, for example, a physical key, a capacitive key, a pointing device, a touch screen integrated with a display, or a microphone that receives voice input. The input interface may further include a camera that captures images or image codes, or an IC card reader. Input unit 125 accepts an operation to input information used for the operation of control unit 123 and sends the input information to control unit 123.

The output unit 126 includes one or more output interfaces. The output interface is, for example, a display or a speaker. The display is, for example, a Liquid Crystal Display (LCD) or an Electro-Luminescence (organic EL) display. The output unit 126 outputs information obtained by the operation of the control unit 123.

The detection unit 127 has an interface with one or more sensors that detect the state of each part of the power supply vehicle 12, or has one or more sensors. The sensor includes, for example, a sensor that detects the remaining battery level of the battery 15, a sensor that detects the motion state (speed, longitudinal acceleration, lateral acceleration, deceleration, etc.) of the power supply vehicle 12, and the like. The detection unit 127 sends information indicating each state detected by the sensor to the control unit 123.

Functions of the control unit 123 are realized by executing a control program by a processor included in the control unit 123. The control program is a program for causing a computer to execute a step process included in the operation of the control unit 123, thereby causing the computer to realize a function corresponding to the step process. That is, the control program is a program for causing the computer to function as the control unit 123. Also, part or all of the functions of the control unit 123 may be realized by a dedicated circuit included in the control unit 123.

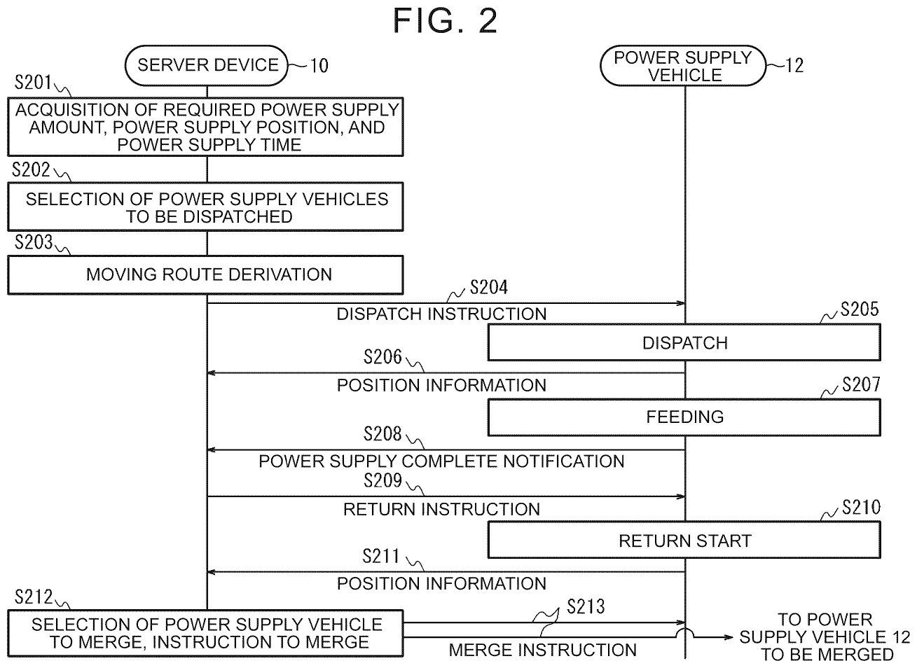

FIG. 2 is a sequence diagram showing an example of a procedure for cooperative operation between the server device 10 and the power supply vehicle 12. Steps related to various information processing of the server device 10 and the power supply vehicle 12 in FIG. 2 are executed by the control units 103 and 123, respectively. Further, the steps related to transmission and reception of various information of the server device 10 and the power supply vehicle 12 are executed by the respective control units 103 and 123 transmitting and receiving information to and from each other via the communication units 101 and 121, respectively. In the server device 10 and the power supply vehicle 12, the control units 103 and 123 respectively store information to be processed and transmitted/received in the storage units 102 and 122 as appropriate.

The procedure of FIG. 2 is an example of the procedure when the server device 10 dispatches the power supply vehicle 12 for rush charging. The procedure of FIG. 2 is executed when the server device 10 determines that the emergency vehicle needs to be charged. For example, when the server device 10 receives a power supply request sent from another vehicle such as a BEV, HEV, or PHEV, or determines that the vehicle is out of power based on the remaining battery level of each vehicle collected from other vehicles.

Then, the server device 10 determines the necessity of emergency charging. Determination of an electric shortage vehicle is made by each vehicle or the server device 10. For example, if the State of Charge (SOC) value of the vehicle's battery falls below an arbitrary criterion, such as 0 to 20%, the vehicle is determined to be out of power.

In S201, the server device 10 acquires the required power supply amount, power supply position, and power supply time. The server device 10 sends information requesting such information to the vehicle with the power failure, and acquires the information sent from the vehicle with the power failure in response to this. The required power supply amount is the amount of electric power required to reach an arbitrary reference remaining amount in an electric vehicle, and is sent from the electric vehicle. An arbitrary reference remaining amount is, for example, an arbitrary SOC value between 80% and 100%. The power supply position is the current position of the vehicle that is out of power, and corresponds to the power supply destination of the power supply vehicle 12. The power supply time is the time at which power supply should be started, which is determined in the vehicle without power. The power feeding time is, for example, a time advanced by an arbitrary required power feeding time from the scheduled start time set for the vehicle with the power failure, and is sent from the power failure vehicle to the server device 10. Also, the power supply time may be specified by the passenger of the vehicle with no electricity and sent to the server device 10.

When the server device 10 determines that a plurality of vehicles are electrically deficient vehicles, the server device 10 identifies one electrically deficient vehicle by an arbitrary algorithm, and executes the procedures from S202 onward for each of the electrically deficient vehicles. For example, the first determined electric-lack vehicle, the electric-lack vehicle that requires the largest amount of power supply, and the like are specified.

In S202, the server device 10 selects the power supply vehicle 12 to perform rush charging. The server device 10 requests position information and remaining battery level information for each power supply vehicle 12 from one or more power supply vehicles 12 waiting at a charging station, and acquires information sent from each power supply vehicle 12 in response to the request. The battery remaining amount information is, for example, the SOC value of the battery 15. Then, the server device 10 selects, for example, the power supply vehicle 12 with the maximum remaining battery level within an arbitrary distance range from the power-supplying position. The arbitrary distance range is, for example, a distance range within which the power feeding position can be reached by the power feeding time when moving at a legal speed.

In S203, the server device 10 derives the moving route of the selected power supply vehicle 12. The moving route is, for example, a route that can reach the power feeding position in the shortest distance or time from the current position of the power supply vehicle 12. The server device 10 uses map information to derive a movement route by an arbitrary algorithm.

In S204, the server device 10 sends a dispatch instruction to the selected power supply vehicle 12. The dispatch instruction includes information on the movement route.

In S205, the power supply vehicle 12 is dispatched according to the dispatch instruction. The power supply vehicle 12 starts moving along the moving route. Alternatively, the power supply vehicle 12 displays the moving route to the passenger and starts moving according to the operation of the passenger. While moving, in S206, the power supply vehicle 12 sends position information to the server device 10 at an arbitrary cycle, for example, at a cycle of several microseconds to several seconds. As a result, the server device 10 grasps the position of the power supply vehicle 12 that is on the move.

When the power supply vehicle 12 reaches the power-supplying position, power is supplied from the power supply vehicle 12 to the vehicle without electricity in S207. For example, the power supply vehicle 12 provides electric power for power supply of the battery 15 to the power supply vehicle by the operation of the passenger or the operation of the automatic machine. When supplying power to a plurality of electric-deficient vehicles at a plurality of power feeding positions, the power supply vehicle 12 executes S206 and S207 for each power feeding position.

When the power supply at all power supply positions is completed, the power supply vehicle 12 sends a power supply completion notification indicating that the power supply has been completed to the server device 10 in S208. Information such as the power supply completion time and the power supply amount is added to the power supply completion notification, for example. Then, in S209, the server device 10 sends a return instruction to the power supply vehicle 12 in response to the power supply completion notification. The return instruction is added with, for example, information on a movement route for moving to the charging station (hereinafter referred to as a return route).

In S210, the power supply vehicle 12 starts returning in response to the return instruction. The power supply vehicle 12 starts moving along the return route. Alternatively, the power supply vehicle 12 displays the return route to the occupant and starts moving according to the occupant's operation. While moving, in S211, the power supply vehicle 12 sends position information to the server device 10 at an arbitrary cycle. Thereby, the server device 10 grasps the position of the power supply vehicle 12 that is returning.

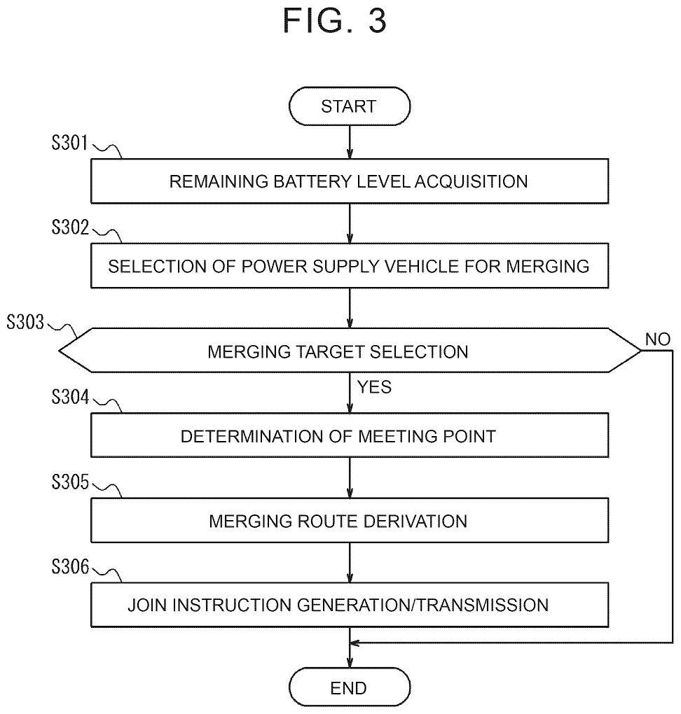

In S212, the server device 10 selects a power supply vehicle to join the power supply vehicle 12 returning, and generates a merging instruction. A detailed procedure example of S212 is shown in FIG. 3.

FIG. 3 is a flowchart for explaining an example of an operation procedure by the server device 10. The procedure of FIG. 3 is executed by the control unit 103 of the server device 10.

In S301, the control unit 103 acquires the remaining battery level of the power supply vehicle 12 that is returning. The control unit 103 requests information on the remaining battery level from the power supply vehicle 12 that is returning, and acquires information sent from the power supply vehicle 12 in response to this request. The remaining battery capacity is, for example, an SOC value.

In S302, the control unit 103 selects, as a merging target, the power supply vehicle 12 that is on the way out and to which the power supply vehicle 12 that is returning is to join. The control unit 103 requests the remaining battery level information for each power supply vehicle 12 from the power supply vehicles 12 that are on the move, that is, the power supply vehicles 12 that have not received the power supply completion notification, and obtains information sent from each power supply vehicle 12 in response to the request.

Then, the control unit 103 selects, for example, the power supply vehicle 12 closest to the return route from among the power supply vehicles 12 on the move whose remaining battery level does not meet an arbitrary reference, as a merging target. An arbitrary criterion is, for example, an SOC value of 40% to 50%, or the required power supply of the electric-failed vehicle to which it is provided. Alternatively, the control unit 103 selects, as a merging target, the power supply vehicle 12 with the smallest remaining battery level among the power supply vehicles 12 that are on the move and the power supply vehicles 12 that are returning are located within an arbitrary distance range from each movement route. . Such an arbitrary distance range is, for example, a range of distances that can reach the power feeding position by the power feeding time when each power supply vehicle 12 moves from the current position at the legal speed.

If the power supply vehicle 12 to be merged is selected (Yes in S303), the control unit 103 determines a merging point in S304. The confluence point is in the vicinity of the movement route of the power supply vehicle 12 to be merged, for example, the middle point of the shortest route from the position of the power supply vehicle 12 returning to the movement route of the power supply vehicle 12 to be merged, or closer to the movement path than the middle point, Alternatively, it is set on the moving route. By doing so, it is possible to minimize the time loss in the power supply vehicle 12 that is on the move.

In S305, the control unit 103 derives a movement route for moving the power supply vehicle 12 that is to be joined and the power supply vehicle that is returning from the current position to the joining point as the joining route. A confluence route is derived by an arbitrary algorithm and is the shortest route or the fastest possible route.

In S306, the control unit 103 generates and sends a merging instruction to each of the merging target power supply vehicle 12 that is dispatched and the power supply vehicle 12 that is returning. Information on each merging route is added to the merging instruction.

Returning to FIG. 2, in S213 after S212, the server device 10 sends a joining instruction to the power supply vehicle 12 returning and the power supply vehicle 12 in dispatch. The power supply vehicle 12 returning and the power supply vehicle 12 dispatching each start moving in response to the merging instruction, or output the contents of the instruction to the occupant and start moving according to the occupant's operation, and move to the merging point. When the power supply vehicles 12 join together at the junction, the remaining power is provided from the power supply vehicle 12 returning to the power supply vehicle currently dispatched.

On the other hand, if the power supply vehicle 12 to be merged is not selected in FIG. 3 (No in S303), the control unit 103 ends the procedures in FIGS. 3 and 2 without determining the meeting point in S304 to S306.

In the modified example, the server device 10 acquires information on the remaining power after power is supplied from the power supply vehicle 12 that is returning to the power supply vehicle 12 that has joined and is on the move. Then, when the next cycle of the operation procedure of FIG. 2 is executed, when a power-deficient vehicle that can supply the remaining power of the returning power supply vehicle 12 is determined, on the condition that the power-depleted vehicle is located within an arbitrary distance range (for example, several hundred meters to several kilometers) from the return route, the returning power supply vehicle 12 may be instructed to be dispatched again.

As described above, when the power supply vehicle 12 that is dispatched supplies power via a plurality of supply destinations, even if the power for power supply is reduced, the remaining power of the power supply vehicle 12 that is returning is reduced. By receiving the supply, it is possible to replenish the power, and it becomes possible to more reliably avoid falling into a shortage of power for power supply. Therefore, it is possible to improve the efficiency of replenishment of the electric power for power supply to the power supply vehicle 12.

Although the embodiment has been described above based on the drawings and examples, it should be noted that those skilled in the art can easily make various modifications and alterations thereto based on the present disclosure. It should be noted, therefore, that these modifications and alterations are within the scope of the present disclosure. For example, the functions included in each means, each step, etc. can be rearranged so as not to be logically inconsistent, and a plurality of means, steps, etc. can be combined into one or divided.

What is claimed is:

1. A server device comprising:
a communication unit; and
a control unit that communicates through the communication unit with a plurality of power supply vehicles to be dispatched from a supply base of power to a supply destination of the power and return to the supply base, and that instructs a first power supply vehicle returning and a second power supply vehicle dispatched to meet each other at a meeting point and supply remaining power in the first power supply vehicle to the second power supply vehicle.

2. The server device according to claim 1, wherein the control unit sets the meeting point near a travel route of the second power supply vehicle to the supply destination.

3. The server device according to claim 1, wherein the control unit instructs the first power supply vehicle to supply remaining power left after supplying the remaining power to the second power supply vehicle to a further supply destination.

4. The server device according to claim 1, wherein the control unit instructs the first power supply vehicle having an amount of power expected to be supplied at the supply destination by the second power supply vehicle to head for the meeting point.
